(19) United States
(12) Patent Application Publication
(10) Pub. No.: US 2026/0175936 A1
(43) Pub. Date: Jun. 25, 2026

(54) THREE-WHEELED MOTORCYCLE AND ADVERTISING KIT

(71) Applicant: ADATA TECHNOLOGY CO., LTD., NEW TAIPEI CITY (TW)

(72) Inventors: Po-Hsien Chen, New Taipei City (TW); YU-CHENG CHIANG, New Taipei City (TW); TSAI-MIN CHIANG, Hsinchu County (TW); WEN-LONG CHEN, Taipei City (TW)

(21) Appl. No.: 19/000,711

(22) Filed: Dec. 24, 2024

(30) Foreign Application Priority Data
Dec. 20, 2024 (TW) 113149786

(51) Int. Cl. B62J 50/25; B62J 9/26; B62K 5/027; G09F 13/04; G09F 21/04

(52) U.S. Cl. CPC B62J 50/25; B62J 9/26; B62K 5/027; G09F 13/044; G09F 21/048

(57) ABSTRACT

A three-wheeled motorcycle and an advertising kit are provided. The three-wheeled motorcycle includes a motorcycle body and an advertising kit. The advertising kit includes four advertising light boxes, and a plurality of advertising boards, pivoting components and fixing assemblies. The advertising light boxes are respectively disposed on four side surfaces of a storage box of the motorcycle body. Each of the advertising light boxes has a box body and a cover. The box body has a storage space that can accommodate the advertising boards. The cover is magnetically attached to the box body to close the opening of the storage space. Two of the advertising light boxes are rotatable relative to the storage box, and can be rotated to abut against each other, so as to form a triangular structure together with the storage box. Another two of the advertising light boxes are fixed on the storage box.

### CROSS-REFERENCE TO RELATED PATENT APPLICATION

This application claims the benefit of priority to Taiwan Patent Application No. 113149786, filed on Dec. 20, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a three-wheeled motorcycle and an advertising kit, and more particularly to a three-wheeled motorcycle with a storage box and an advertising kit for installation on the storage box of the three-wheeled motorcycle.

### BACKGROUND OF THE DISCLOSURE

In recent years, for manufacturers wishing to place advertisements, there are few places in physical channels where advertisements can be placed. Most of the locations where advertisements can be placed are fixed and immobile.

### SUMMARY OF THE DISCLOSURE

In response to the above-referenced technical inadequacy, the present disclosure provides a three-wheeled motorcycle and an advertising kit, primarily aimed at improving the placement of existing physical advertisements, which are mostly limited to fixed locations and unable to move.

In order to solve the above-mentioned problems, one of the technical aspects adopted by the present disclosure is to provide an advertising kit for installation on an exterior of a storage box of a three-wheeled motorcycle. The advertising kit includes four advertising light boxes, a plurality of advertising boards, a plurality of pivoting components, and a plurality of fixing assemblies. The four advertising light boxes are respectively disposed on four side surfaces of the storage box. Each of the four advertising light boxes has a box body and a cover, the box body has a storage space and a plurality of first magnetic components, and the cover has a plurality of second magnetic components. Each of the first magnetic components is capable of adhering to each of the second magnetic components, the cover is configured to be detachably mounted on the box body through the second magnetic components, and the cover is capable of closing an opening of the storage space. Each of a plurality of box bodies of the four advertising light boxes has at least one of a plurality of lighting units. Each of the advertising boards is disposed in one of a plurality of storage spaces of the box bodies, and is configured to be replaced through the opening. The lighting units are configured to illuminate the advertising boards.

Two of the four advertising light boxes located on two opposite ones of the four side surfaces of the storage box are rotatably connected to the storage box through the pivoting components. When the two of the four advertising light boxes are rotated, one side of the two advertising light boxes is configured to butt against each other, so as to form a triangular structure together with the storage box. Another two of the four advertising light boxes are fixed to another two of the four side surfaces of the storage box through the fixing assemblies.

In order to solve the above-mentioned problems, another one of the technical aspects adopted by the present disclosure is to provide a three-wheeled motorcycle. The three-wheeled motorcycle includes a motorcycle body and an advertising kit. The motorcycle body has a storage box disposed on a rear seat thereof. The advertising kit includes four advertising light boxes, a plurality of advertising boards, a plurality of pivoting components, and a plurality of fixing assemblies. The four advertising light boxes are respectively disposed on four side surfaces of the storage box. Each of the four advertising light boxes has a box body and a cover, the box body has a storage space and a plurality of first magnetic components, and the cover has a plurality of second magnetic components. Each of the first magnetic components is capable of adhering to each of the second magnetic components, the cover is configured to be detachably mounted on the box body through the second magnetic components, and the cover is capable of closing an opening of the storage space. Each of the advertising boards is disposed in one of a plurality of storage spaces of the box bodies, and is configured to be replaced through the opening. The lighting units are configured to illuminate the advertising boards. Two of the four advertising light boxes located on two opposite ones of the four side surfaces of the storage box are rotatably connected to the storage box through the pivoting components. When the two of the four advertising light boxes are rotated, one side of the two advertising light boxes is configured to butt against each other, so as to form a triangular structure together with the storage box. Another two of the four advertising light boxes are fixed to another two of the four side surfaces of the storage box through the fixing assemblies.

Therefore, the advertising kit of the present disclosure can be installed on the exterior of the storage box of the three-wheeled motorcycle, and one of the advertising boards is set up within the advertising light box. Accordingly, the three-wheeled motorcycle can achieve the effect of displaying advertisements while in motion.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a three-wheeled motorcycle according to one embodiment of the present disclosure;

FIG. 2 is another schematic view of the three-wheeled motorcycle according to one embodiment of the present disclosure;

FIG. 3 is a schematic view of a storage box of the three-wheeled motorcycle according to one embodiment of the present disclosure;

FIG. 4 is a schematic partial exploded view of the storage box and an advertising kit of the three-wheeled motorcycle according to one embodiment of the present disclosure;

FIG. 5 is a schematic view of an fixed light box of the advertising kit with a plurality of fixing assemblies according to one embodiment of the present disclosure;

FIG. 6 is a schematic enlarged view of a section of FIG. 5;

FIG. 7 is a schematic exploded view of partial components in FIG. 6;

FIG. 8 is a schematic enlarged view of a section of FIG. 3;

FIG. 9 is a schematic exploded view of partial components in FIG. 8;

FIG. 10 is a schematic partial exploded view of the storage box and the advertising kit of the three-wheeled motorcycle according to one embodiment of the present disclosure;

FIG. 11 is another schematic view of the storage box and the advertising kit of the three-wheeled motorcycle according to one embodiment of the present disclosure;

FIG. 12 is a schematic enlarged view of a section of FIG. 11;

FIG. 13 is a schematic operational view of a snap-lock assembly in FIG. 12; and

FIG. 14 is a schematic partial exploded view of the storage box and the advertising kit of the three-wheeled motorcycle according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

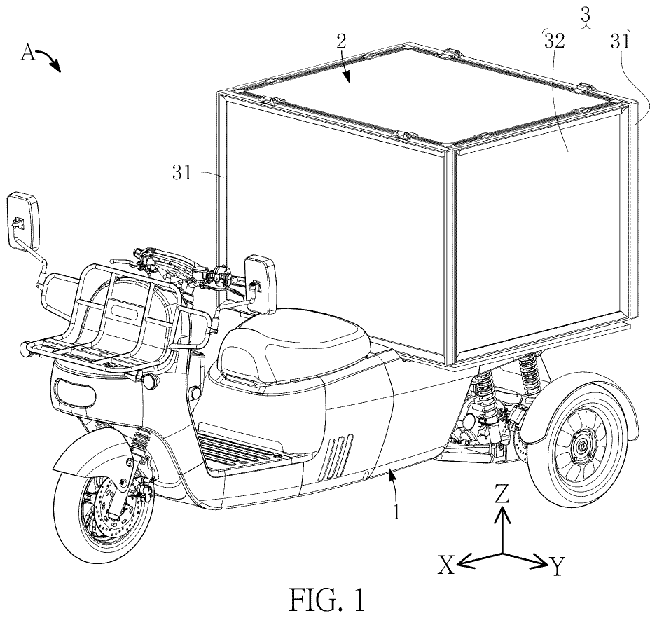

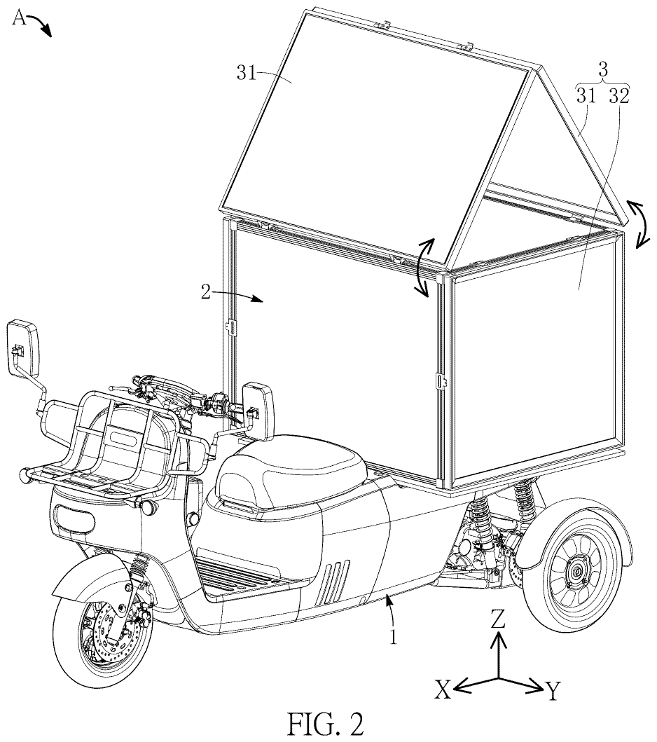

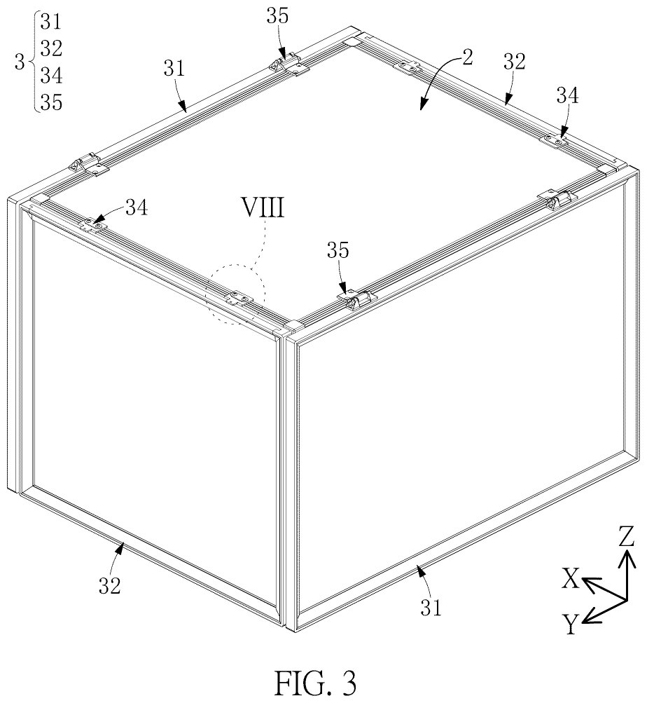

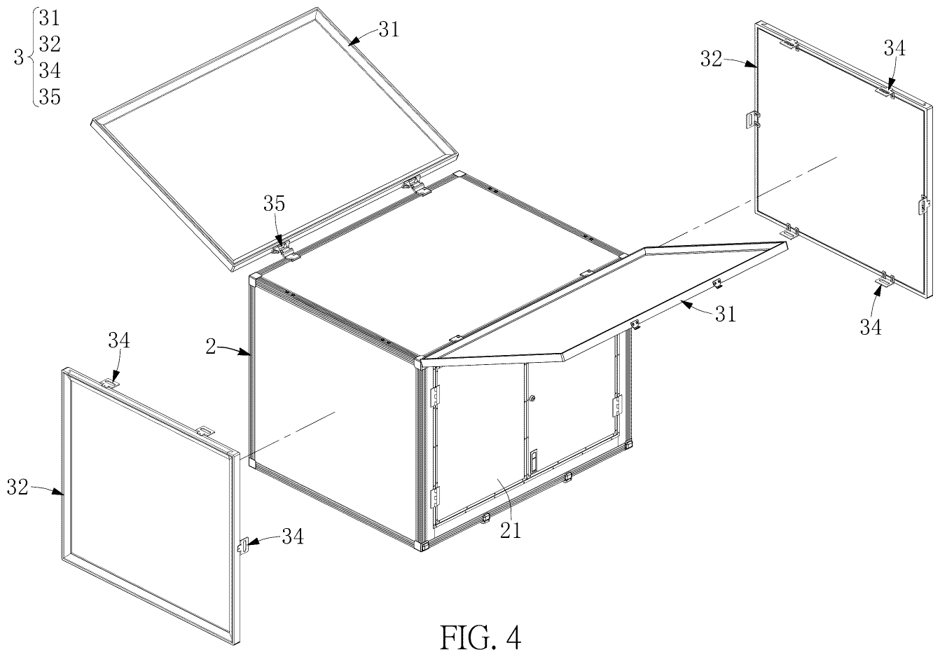

Referring to FIG. 1 to FIG. 4, FIG. 1 is a schematic view of a three-wheeled motorcycle according to one embodiment of the present disclosure, FIG. 2 is another schematic view of the three-wheeled motorcycle according to one embodiment of the present disclosure, FIG. 3 is a schematic view of a storage box of the three-wheeled motorcycle according to one embodiment of the present disclosure, and FIG. 4 is a schematic partial exploded view of the storage box and an advertising kit of the three-wheeled motorcycle according to one embodiment of the present disclosure.

The three-wheeled motorcycle A in the present disclosure includes a motorcycle body 1 and an advertising kit 3 of the present disclosure. The motorcycle body 1 can be exemplified to be an electric motorcycle, a gasoline-powered motorcycle, etc., but the present disclosure is not limited thereto. A storage box 2 is installed on a rear seat of the motorcycle body 1. The three-wheeled motorcycle A of the present disclosure can be used as a logistics delivery vehicle for logistics operators, but the present disclosure is not limited thereto. The storage box 2 can be exemplified to be a rectangular cuboid, and the storage box 2 may include at least one movable door 21. The at least one movable door 21 can be exemplified to be installed on a top surface or a side surface of the storage box 2, but the present disclosure is not limited thereto.

The advertising kit 3 of the present disclosure includes four advertising light boxes, four advertising boards 33, a plurality of fixing assemblies 34, and four pivoting components 35. The four advertising light boxes are fixed on four side surfaces of the storage box 2. Two of the four advertising light boxes are defined as rotating light boxes 31, and another two of the four advertising light boxes are defined as fixed light boxes 32.

It should be noted that, in the example where the movable door 21 of the storage box 2 is installed on one of the four side surfaces adjacent to each other, one of the fixed light boxes 32 should not be installed on one of the side surface of the storage box 2 with the movable door 21 during installation, and the side surface of the storage box 2 with the movable door 21 should be fitted with a rotating light box 31. With the arrangement, the use of the storage box 2 by relevant personnel will not be affected. Each of the four advertising light boxes has a box body 321 and a cover 322.

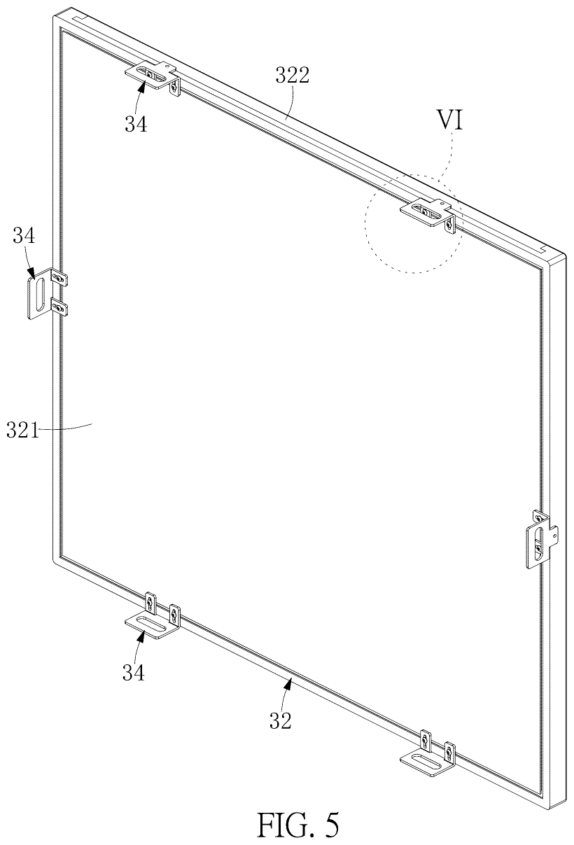

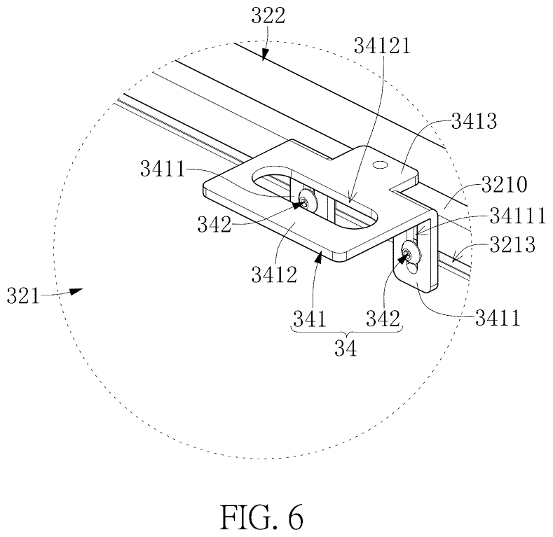

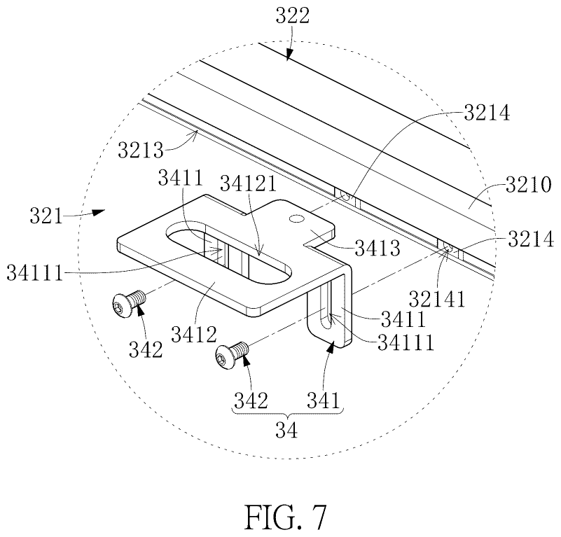

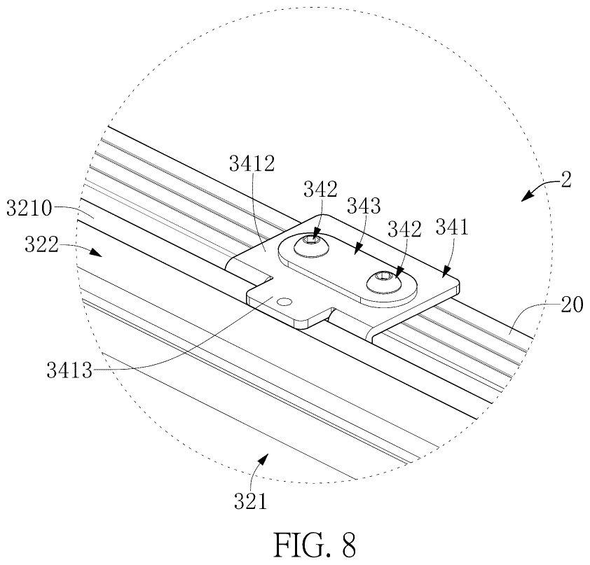

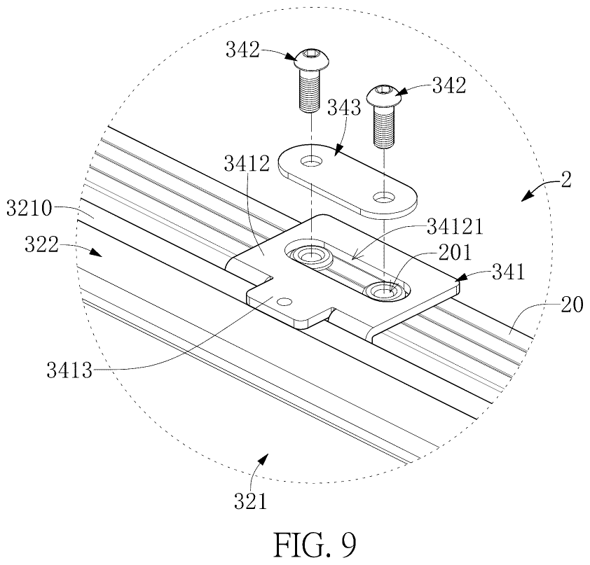

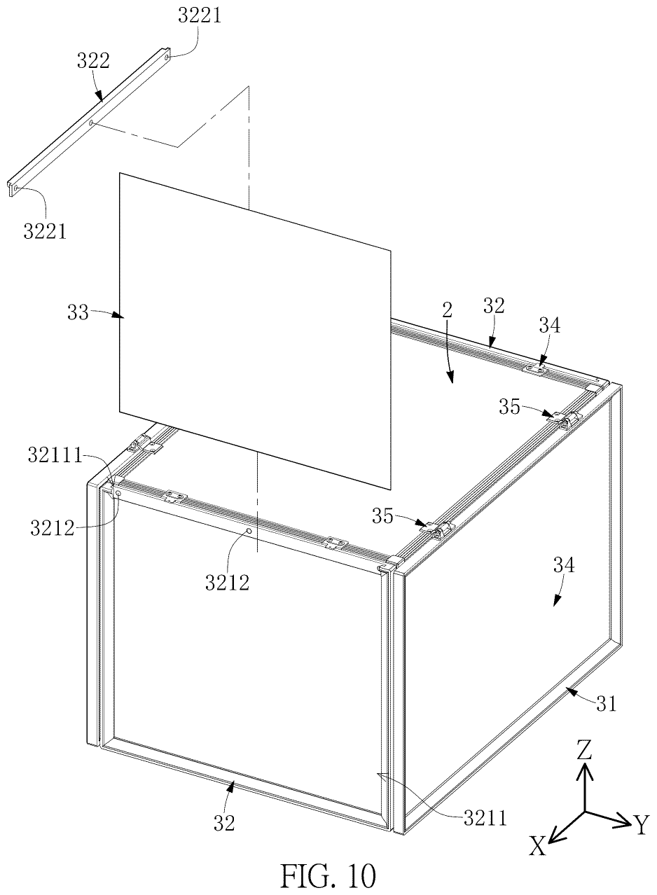

Referring to FIG. 4 to FIG. 10, FIG. 4 is a schematic partial exploded view of the storage box and an advertising kit of the three-wheeled motorcycle according to one embodiment of the present disclosure, FIG. 5 is a schematic view of an fixed light box of the advertising kit with a plurality of fixing assemblies according to one embodiment of the present disclosure, FIG. 6 is a schematic enlarged view of a section of FIG. 5, FIG. 7 is a schematic exploded view of partial components in FIG. 6, FIG. 8 is a schematic enlarged view of a section of FIG. 3, FIG. 9 is a schematic exploded view of partial components in FIG. 8, and FIG. 10 is a schematic partial exploded view of the storage box and the advertising kit of the three-wheeled motorcycle according to one embodiment of the present disclosure.

Each of the fixed light boxes 32 can be fixed to one of the side surfaces of the storage box 2 through a plurality of fixing assemblies 34. In one specific embodiment, each of the fixed light boxes 32 on the side surface facing the box body 321 may have a groove 3213 (as shown in FIG. 6). The groove 3213 is used to accommodate at least one auxiliary locking component 3214 (as shown in FIG. 7). The at least one auxiliary locking component 3214 can be exemplified to be a nut or a plate with a lock hole. Each of the fixing assemblies 34 can be exemplified to include a fixing piece 341 and a plurality of locking pieces 342. Each of the locking pieces 342 can be exemplified to be a screw.

The fixing piece 341 can be exemplified to include two side fixing portions 3411, a carriage fixing portion 3412, and a supporting portion 3413.

The carriage fixing portion 3412 and the supporting portion 3413 can be plate-like structures, and the carriage fixing portion 3412 and the supporting portion 3413 can be generally located in the same plane. A size of the carriage fixing portion 3412 can be slightly larger than a size of the supporting portion 3413, and both the carriage fixing portion 3412 and the supporting portion 3413 can jointly form a structure similar to the shape of the Chinese character “ [symbol] ”.

In practical application, the two side fixing portions 3411, the carriage fixing portion 3412, and the supporting portion 3413 of the fixing piece 341 can be an integrally formed structure. The supporting portion 3413 can be formed by extending outward from one side edge of the carriage fixing portion 3412, and the two side fixing portions 3411 can be formed by bending towards a side surface from the side edge of the supporting portion 3413.

Each of the two side fixing portions 3411 can have a through hole 34111, and each of the two side fixing portions 3411 is used to abut against a side surface of the box body 321. The side surface of the box body 321 can have a groove 3213 that is used to accommodate at least one auxiliary locking component 3214. The auxiliary locking component 3214 be exemplified to be a plate-like structure, and the auxiliary locking component 3214 has a lock hole 32141. Each of the two side fixing portions 3411 abuts against the side surface of the box body 321. When the lock hole 32141 of each of the auxiliary locking components 3214 is positioned corresponding to the through hole 34111 of each of the two side fixing portions 3411, each of the locking pieces 342 can pass through the through hole 34111 of the side fixing portion 3411 and interlock with the lock hole 32141. Accordingly, the two side fixing portions 3411 are mutually fixed with the box body 321.

As shown in FIG. 6 to FIG. 9, the carriage fixing portion 3412 can be exemplified to have a through hole 34121 that is used to allow the locking piece 342 to pass through. When the carriage fixing portion 3412 abuts against the top surface 20 of the storage box 2, the lock hole 201 located on the top surface 20 can be exposed through the through hole 34121, and the locking piece 342 can interlock with the lock hole 201 through the through hole 34121. Accordingly, the carriage fixing portion 3412 is fixed on the top surface 20 of the storage box 2. In practice, an auxiliary fixing plate 343 can also be set between each locking piece 342 and the carriage fixing portion 3412. A size of the auxiliary fixing plate 343 are larger than a size of the through hole 34121. The auxiliary fixing plate 343 is used to press against the carriage fixing portion 3412, so that a connection strength between the carriage fixing portion 3412 and the storage box 2 is enhanced.

The supporting portion 3413 is used to abut against the top surface 3210 of the box body 321. The locking piece may not be fixed on the supporting portion 3413. Through a design of the supporting portion 3413, the range of movement between the box body 321 and the storage box 2 can be further limited, so as to reduce the possibility of the box body 321 rotating relative to the storage box 2 due to accidental external forces.

Each of the four sides of each of the box bodies 321 can have two of the fixing assemblies 34. However, the quantity of the fixing assemblies 34 installed on each of the four sides is not limited thereto, and can be increased or decreased according to requirement.

Referring to FIG. 1 to FIG. 4, one side of each of the two rotating light boxes 31 can be connected to the storage box 2 through two of the pivoting components 35, and each of the two rotating light boxes 31 can be operated to rotate relative to the storage box 2. When the two rotating light boxes 31 are operated to rotate relative to the storage box 2, the other side edges of the two rotating light boxes 31 can abut against each other, and the two rotating light boxes 31 and the storage box 2 can form a structure similar to a triangle. The design allows the four advertising boards 33 installed in the two rotating light boxes 31 to more easily attract the attention of passersby.

In other words, each of the pivoting components 35 is disposed on the top sides of the two rotating light boxes 31, and each of the two rotating light boxes 31 can be operated to flip upwards relative to the storage box 2. The two rotating light boxes 31, after being flipped upwards, can then abut against each other. In practice, the two rotating light boxes 31 that abut against each other can be reinforced for stability through any fixing means. For example, magnetic components can be disposed on the bottom of each of the two rotating light boxes 31. The magnetic components of the two rotating light boxes 31 that abut against each other can attract each other. Accordingly, a connection strength between the two rotating light boxes 31 can be enhanced.

Referring to FIG. 10, each of the box bodies 321 has a storage space 3211 and a plurality of first magnetic components 3212. The cover 322 has a plurality of second magnetic components 3221, and each of the first magnetic components 3212 can magnetically attract each of the second magnetic components 3221. The cover 322 can be removably disposed on the box body 321 through the second magnetic components 3221, and the cover 322 can be used to close an opening 32111 of the storage space 3211.

Each of the four advertising boards 33 is disposed in each of the storage spaces 3211, and can be replaced through the opening 32111. Since the cover 322 is mutually fixed to the box body 321 through the cooperation of the second magnetic components 3221 and the first magnetic components 3212, relevant personnel intending to replace different advertising boards 33 can directly remove the cover 322 by hand without using any other tools, so that the opening 32111 is exposed. Accordingly, the advertising board 33 in the storage space 3211 can be replaced.

At least one lighting unit (not shown in the figure) is disposed in each of the box bodies 321. The lighting unit is used to illuminate the advertising board 33 located in the storage space 3211. In one application, the advertising board 33 can be made of light-transmitting material. The lighting unit can illuminate the advertising board 33 from behind in a backlight manner, or the lighting unit can also be disposed on the side of the box body 321 and illuminate the advertising board 33 in a side-emitting direction. The lighting unit can be, for example, an LED light strip.

In practice, to allow the light beams emitted by the lighting unit to evenly illuminate the advertising board 33, components such as light guide plates and light diffusion sheets can be disposed in the box body 321. Accordingly, the light beam emitted by the lighting unit is evenly illuminated on the advertising board 33 through the light guide plate, light uniformity sheet and other components.

It should be noted that, in practice, each of the four advertising light boxes 31 can also include a transparent partition fixed in the box body 321. The transparent partition and the box body 321 jointly form the storage space 3211, and the transparent partition and the box body 321 can be exemplified to jointly form a waterproof storage space 3211.

Regarding the material of the advertising boards 33 and the components whereof includes can be designed according to actual requirements. For example, in example where the advertising light box 31 has a transparent partition, the advertising board 33 can be a translucent cardboard or similar material. In example where the advertising light box 31 does not have a transparent partition, the advertising board 33 can include an acrylic board with advertising paper sandwiched between the acrylic boards.

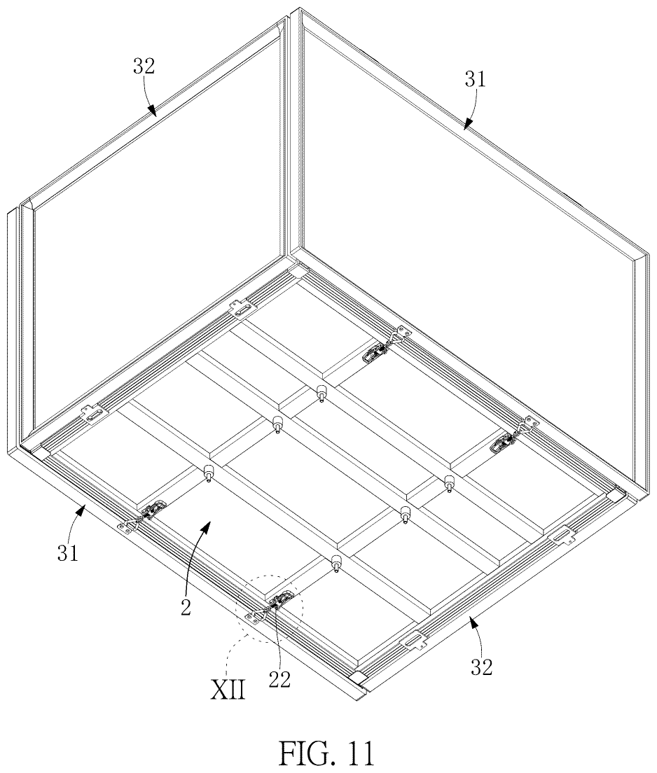

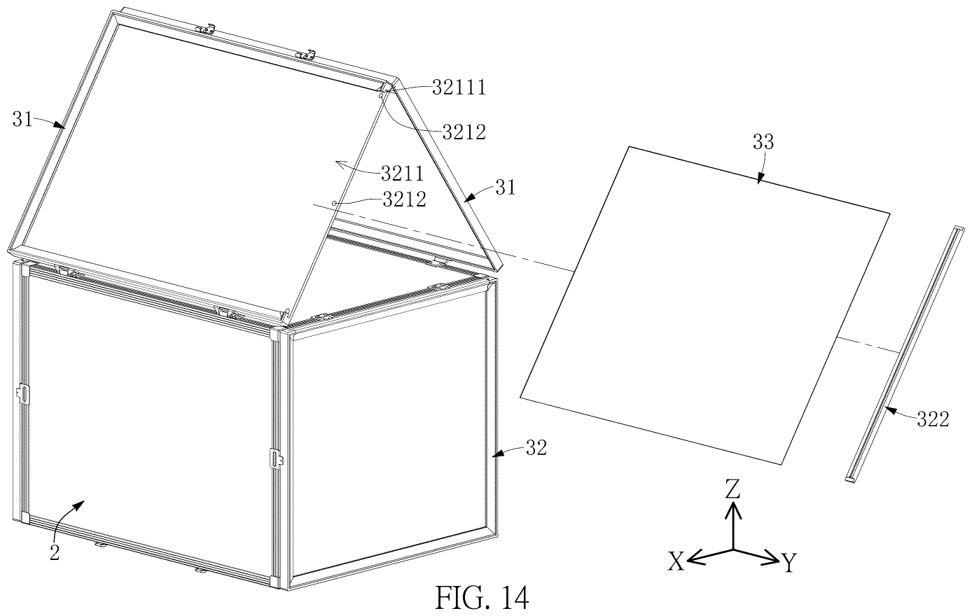

Referring to FIG. 4, and FIG. 11 to FIG. 14, each of the two rotating light boxes 31 has two opposing side edges, the pivoting components 35 and the snap-lock assemblies 22 can be respectively disposed on the two opposite side edges of each of the two rotating light boxes 31. The cover 322 is disposed on one of side edges of each of the two rotating light boxes 31 that is not connected to the pivoting component 35 or the snap-lock assembly 22 In other words, the cover 322 of each of two rotating light boxes 31 can be installed on a left side or a right side of the box body 321. The design allows users to easily replace the advertising board 33.

One of the two opposing side edges of each of the two rotating light boxes 31 is connected to the storage box 2 by the pivoting components 35, and another one of the two opposing side edges each of the two rotating light boxes is connected to the storage box 2 by the snap-lock assemblies 22. A locking component 311 is disposed on one side of the rotating light box 31 opposite to the pivoting components 35. The locking component 311 is used to cooperate with an adjacent snap-lock assembly 22 to jointly restrict the range of movement of the rotating light box 31.

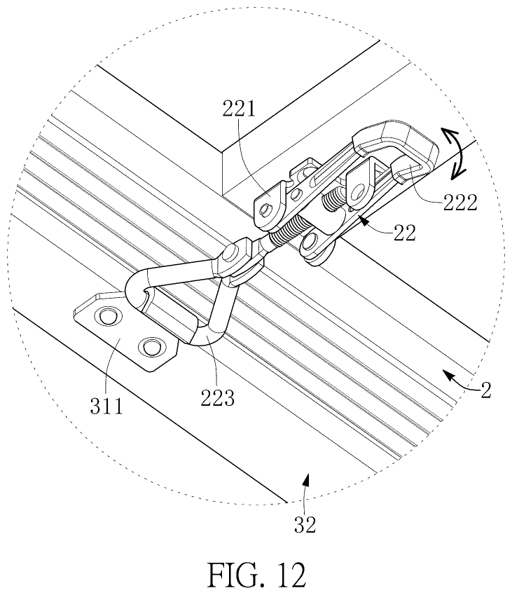

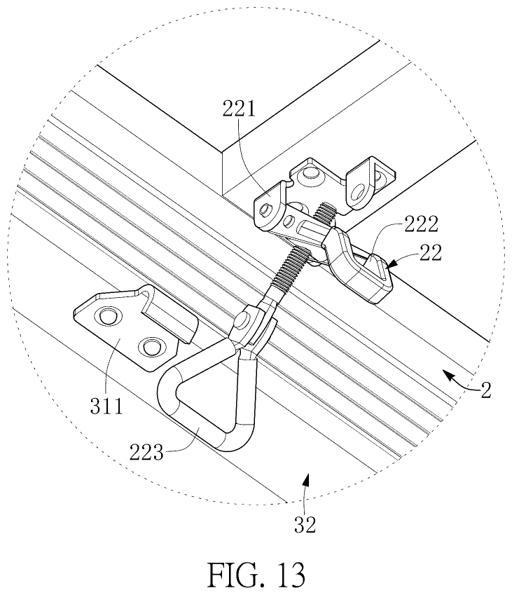

Each of the snap-lock assemblies 22 is configured to be operated to switch between a locked state (as shown in FIG. 12) and a movable state (as shown in FIG. 13). Specifically, the snap-lock assembly 22 can include a base 221, an operating member 222, and a latch member 223. The base 221 is fixed to the storage box 2, the operating member 222 is rotatably connected to the base 221, and the latch member 223 is connected to the operating member 222. The locking component 311 is, for example, a hook-shaped structure.

When the snap-lock assembly 22 is in the locked state (that is, when the locking component 311 and the latch member 223 are interlocked with each other), relevant personnel can rotate the operating member 222 in a direction away from the base 221. Accordingly, the latch member 223 is driven by the operating member 222 to disengage from the locking component 311, so that the snap-lock assembly 22 is converted to the movable state.

Referring to FIG. 12, when the snap-lock assembly 22 is in the locked state, the hook-shaped structure (i.e., the locking component 311) is hooked onto the latch member 223, so that the rotating light box 31 cannot rotate relative to the storage box 2. Referring to FIG. 13, when all the snap-lock assemblies 22 connected to the rotating light box 31 are in the movable state, the hook-shaped structure (i.e., the locking component 311) is not hooked onto the latch member 223, so that the rotating light box 31 can rotate relative to the storage box 2.

It should be noted that the snap-lock assembly 22 and the locking component 311 shown in the figure are only one demonstrative embodiment. As long as the snap-lock assembly 22 can cooperate with the locking component to jointly restrict the range of movement between the rotating light box 31 and the storage box 2, the specific external shape, components, etc. of the snap-lock assembly 22 and the locking component 311 can all be designed according to actual requirements.

In conclusion, the three-wheeled motorcycle and the advertising kit of the present disclosure allow advertisers to place advertisements in various urban environments, such as narrow city streets or crowded markets, and due to the mobility of the three-wheeled motorcycle, the display locations of the advertisements can be flexibly changed. Moreover, the advertising kit of the present disclosure can be directly installed on the exterior of the storage box of the three-wheeled motorcycle, so that the advertising kit of the present disclosure can be directly applied to the storage boxes of three-wheeled motorcycles used by logistics providers or delivery services. Furthermore, the advertising kit does not affect the original use of the storage box. Accordingly, logistics providers or delivery services can simultaneously display advertisements along their routes while delivering goods.

The three-wheeled motorcycle and the advertising kit of the present disclosure, through the design of separately installing magnetic components on the cover and box body, so that relevant personnel can directly perform the replacement of the advertising board by hand without using tools. Accordingly, the efficiency of advertisement replacement is improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An advertising kit for installation on an exterior of a storage box of a three-wheeled motorcycle, comprising:
four advertising light boxes respectively disposed on four side surfaces of the storage box; wherein each of the four advertising light boxes has a box body and a cover, the box body has a storage space and a plurality of first magnetic components, and the cover has a plurality of second magnetic components; wherein each of the first magnetic components is capable of adhering to each of the second magnetic components, the cover is configured to be detachably mounted on the box body through the second magnetic components, and the cover is capable of closing an opening of the storage space; and wherein each of a plurality of box bodies of the four advertising light boxes has at least one of a plurality of lighting units;
a plurality of advertising boards; wherein each of the advertising boards is disposed in one of a plurality of storage spaces of the box bodies, and is configured to be replaced through the opening; and wherein the lighting units are configured to illuminate the advertising boards;
a plurality of pivoting components, wherein two of the four advertising light boxes located on two opposite ones of the four side surfaces of the storage box are rotatably connected to the storage box through the pivoting components, and wherein, when the two of the four advertising light boxes are rotated, one side of the two advertising light boxes is configured to butt against each other, so as to form a triangular structure together with the storage box; and
a plurality of fixing assemblies, wherein another two of the four advertising light boxes are fixed to another two of the four side surfaces of the storage box through the fixing assemblies.

2. The advertising kit according to claim 1, wherein one side surface of each of the box bodies has a groove that is configured to be accommodated at least one auxiliary locking component; wherein each of the fixing assemblies includes a fixing piece and a plurality of locking pieces, and the locking pieces are configured to cooperate with the at least one auxiliary locking component, so that the fixing pieces is fixed on one side surface of the box body.

3. The advertising kit according to claim 2, wherein the fixing piece includes at least two side fixing portions, a carriage fixing portion, and a supporting portion; wherein the locking pieces is configured to cooperate with the auxiliary locking component, so that the side fixing portions are fixed on one side surface of the box body; wherein the carriage fixing portion is configured to cooperate with the locking pieces to be fixed on a top surface of the storage box; and wherein the supporting portion is configured to abut against a top surface of the box body.

4. The advertising kit according to claim 1, wherein two of the four advertising light boxes connected to the storage box by the pivoting components are defined as two rotating light boxes; wherein each of the two rotating light boxes has two opposing side edges, one of the two opposing side edges is connected to the storage box by the pivoting components, and another one of the two opposing side edges is connected to the storage box by the snap-lock assemblies; wherein each of the snap-lock assemblies is configured to be operated to switch between a locked state and a movable state; wherein, when the snap-lock assemblies connected to the two rotating light boxes are in the movable state, the two rotating light box is configured to be operated to rotate relative to the storage box; and wherein, when any one of the snap-lock assemblies connected to one of the two rotating light boxes is in the locked state, the rotating light box is configured to be unable to rotate relative to the storage box.

5. The advertising kit according to claim 4, wherein the cover is disposed on one side edge of each of the two rotating boxes that is not connected to one of the pivoting components or the snap-lock assemblies.

6. A three-wheeled motorcycle, comprising:
a motorcycle body having a storage box disposed on a rear seat thereof; and
an advertising kit including:
four advertising light boxes respectively disposed on four side surfaces of the storage box; wherein each of the four advertising light boxes has a box body and a cover, the box body has a storage space and a plurality of first magnetic components, and the cover has a plurality of second magnetic components; and wherein each of the first magnetic components is capable of adhering to each of the second magnetic components, the cover is configured to be detachably mounted on the box body through the second magnetic components, and the cover is capable of closing an opening of the storage space;
a plurality of advertising boards; wherein each of the advertising boards is disposed in one of a plurality of storage spaces of the box bodies, and is configured to be replaced through the opening; and wherein the lighting units are configured to illuminate the advertising boards;
a plurality of pivoting components, wherein two of the four advertising light boxes located on two opposite ones of the four side surfaces of the storage box are rotatably connected to the storage box through the pivoting components, and wherein, when the two of the four advertising light boxes are rotated, one side of the two advertising light boxes is configured to butt against each other, so as to form a triangular structure together with the storage box; and
a plurality of fixing assemblies, wherein another two of the four advertising light boxes are fixed to another two of the four side surfaces of the storage box through the fixing assemblies.

7. The three-wheeled motorcycle according to claim 6, wherein one side surface of each of the box bodies has a groove that is configured to be accommodated at least one auxiliary locking component; and wherein each of the fixing assemblies includes a fixing piece and a plurality of locking pieces, and the locking pieces are configured to cooperate with the at least one auxiliary locking component, so that the fixing pieces is fixed on one side surface of the box body.

8. The three-wheeled motorcycle according to claim 7, wherein the fixing piece includes at least two side fixing portions, a carriage fixing portion, and a supporting portion; wherein the locking pieces is configured to cooperate with the auxiliary locking component, so that the side fixing portions are fixed on one side surface of the box body; wherein the carriage fixing portion is configured to cooperate with the locking pieces to be fixed on a top surface of the storage box; and wherein the supporting portion is configured to abut against a top surface of the box body.

9. The three-wheeled motorcycle according to claim 6, wherein two of the four advertising light boxes connected to the storage box by the pivoting components are defined as two rotating light boxes; wherein each of the two rotating light boxes has two opposing side edges, one of the two opposing side edges is connected to the storage box by the pivoting components, and another one of the two opposing side edges is connected to the storage box by the snap-lock assemblies; wherein each of the snap-lock assemblies is configured to be operated to switch between a locked state and a movable state; wherein, when the snap-lock assemblies connected to the two rotating light boxes are in the movable state, the two rotating light box is configured to be operated to rotate relative to the storage box; and wherein, when any one of the snap-lock assemblies connected to one of the two rotating light boxes is in the locked state, the rotating light box is configured to be unable to rotate relative to the storage box.

10. The three-wheeled motorcycle according to claim 9, wherein the cover is disposed on one side edge of each of the two rotating boxes that is not connected to one of the pivoting components or the snap-lock assemblies.
